(19) United States
(12) Patent Application Publication
(10) Pub. No.: US 2010/0280898 A1
(43) Pub. Date: Nov. 4, 2010

(54) Personalized Reward System

(76) Inventor: Atsushi Kasuya, Los Altos Hills, CA (US)

Correspondence Address: FERNANDEZ & ASSOCIATES, LLP, P.O. BOX D, MENLO PARK, CA, 94026, US

(21) Appl. No.: 12/433,160

(22) Filed: Apr. 30, 2009

(51) Int. Cl. G06Q 30/00

(52) U.S. Cl. 705/14.33

(57) ABSTRACT

A method for a personalized reward system, the method includes obtaining a reward list comprising one or more reward each associated with a corresponding reward point required for a corresponding reward redemption, obtaining a task list comprising one or more tasks each associated with a corresponding reward point that can be earned upon a corresponding task completion, receiving a input from a user indicating a task of the one or more tasks is completed, adding a corresponding reward point associate with the task to generate a cumulative reward point based on a first pre-determined criterion, comparing the cumulative reward point to the reward list based on a second first pre-determined criterion to generate a result, and notifying the user of a reward redemption based on the result.

### BACKGROUND

A to-do list (or a task schedule) is a list of tasks to be completed, such as chores or steps toward completing a project. Task lists are used in self-management, business management, project management, etc. and may involve more than one list. When a user accomplishes one of the items on a to-do list, the user checks it off or crosses it off. Various digital implementations of the to-do list are available (such as a personal information management application) on personal computers and personal digital assistants (PDAs). There are also several web-based to-do list applications. To-do lists are often tiered and/or prioritized. The simplest tiered system includes a general to-do list (or a task list) to record all the tasks the user needs to accomplish, and a periodic to-do list (or a task schedule) which is created periodically (e.g., daily, weekly, monthly, etc.) by transferring tasks from the general to-do list.

A frequent flyer program is a service offered by many airlines to reward customer loyalty. Typically, airline customers enrolled in the program accumulate award points corresponding to the distance flown on that airline. Accrued award points (i.e., accumulated points, also known as frequent flyer miles) can be redeemed for free air travel, other goods or services, or increased benefits such as airport lounge access or priority bookings. Similar to the frequent flyer program, a retail establishment (e.g., a supermarket) or an e-commerce retail website may issue a loyalty card or membership ID to a customer. By presenting the loyalty card or membership ID at the time of purchase, the customer is typically entitled to either a discount on the current purchase or an allotment of award points that can be used for future purchases. The frequent flyer programs and other customer loyalty reward systems are not personalized by the customers.

### SUMMARY

In general, in one aspect, the present invention relates to a method for a personalized reward system, the method includes obtaining a reward list comprising one or more reward each associated with a corresponding reward point required for a corresponding reward redemption, obtaining a task list comprising one or more tasks each associated with a corresponding reward point that can be earned upon a corresponding task completion, receiving a input from a user indicating a task of the one or more tasks is completed, adding a corresponding reward point associate with the task to generate a cumulative reward point based on a first pre-determined criterion, comparing the cumulative reward point to the reward list based on a second first pre-determined criterion to generate a result, and notifying the user of a reward redemption based on the result.

Other aspects and advantages of the invention will be apparent from the following description and the appended claims.

### BRIEF DESCRIPTION OF DRAWINGS

FIG. 1 shows a system block diagram for the personalized reward system according to aspects of the invention.

FIG. 2 shows a flow chart of a method for the personalized reward system according to aspects of the invention.

FIGS. 3-34 depict screen shots of an example personalized reward system according to aspects of the invention.

FIG. 35 shows a computer system using which embodiments of the invention can be implemented.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. In other instances, well-known features have not been described in detail to avoid obscuring the invention.

In general, embodiments of the invention provide a system and method for a personalized reward system. Using this system, a user can set a personalized reward point (Mylage point), and earns the points by performing and/or completing daily tasks. In one or more embodiments, the reward points earned for completing a task in a task list and the required accumulation of earned reward points for reward redemption are pre-determined by the user. In one or more embodiments, the status of a completed task is entered into the personalized reward system by the user. In one or more embodiments, the tallying of earned reward points and the reward redemption analysis are based on per-determined criteria for motivating personal goal setting and prompt task completion. In one or more embodiments, the personalized reward system allows sharing among authorized users.

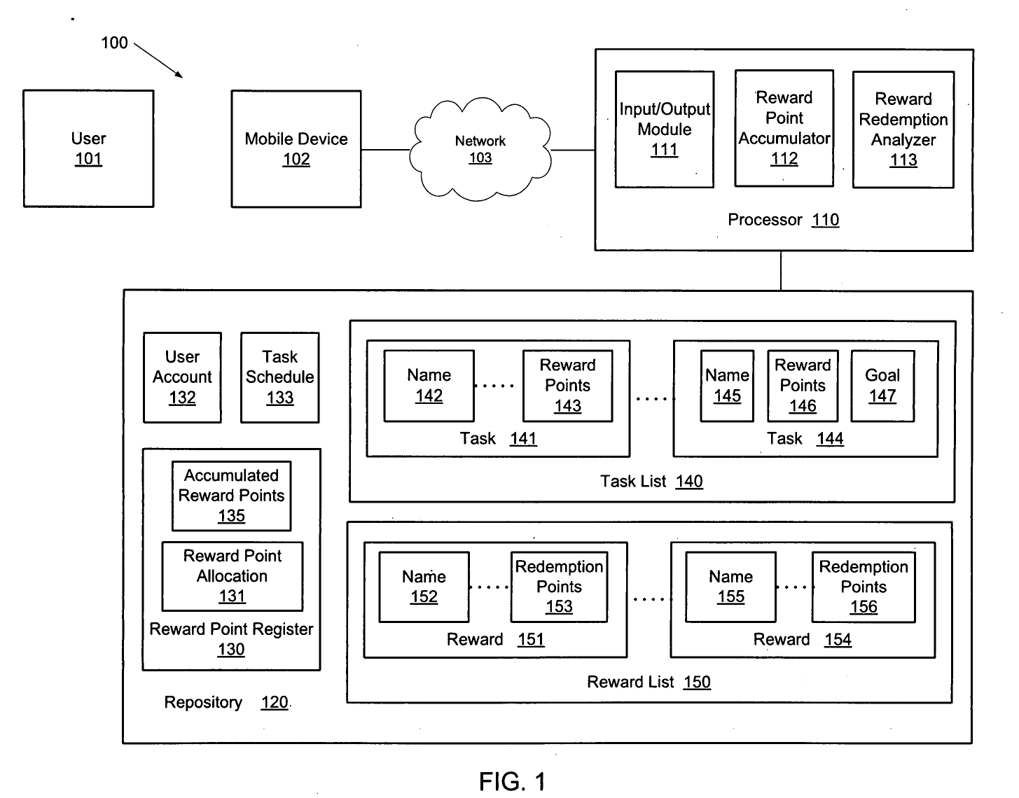

FIG. 1 depicts a schematic block diagram of a personalized reward system (100) and a user (101) in accordance with one or more embodiments of the invention. Those skilled in the art, having the benefit of this detailed description, will appreciate that the components shown in FIG. 1 may differ among embodiments of the invention, and that one or more of the components may be optional. In one or more embodiments of the invention, one or more of the components shown in FIG. 1 may be omitted, repeated, supplemented, and/or otherwise modified from that shown in FIG. 1. Accordingly, the specific arrangement of components shown in FIG. 1 should not be construed as limiting the scope of the invention.

As shown in FIG. 1, the personalized reward system (100) includes a mobile device (102), a network (103), a processor (110), and a repository (120). In addition, the processor (110) includes an input/output module (111), a reward point accumulator (112), and a reward redemption analyzer (113). Further, the repository (120) is shown to store a user account (132), a task schedule (133), a reward point register (130) including an accumulated reward points (135) and an optional reward point allocation (131), a task list (140) including tasks (141, 144, etc.) having names (142, 145, etc.) and corresponding reward points (143, 146, etc.), and a reward list (150) including rewards (151, 154, etc.) having names (152, 155, etc.) and corresponding required redemption points (153, 156, etc.). Although specific number of components are shown in FIG. 1, those skilled in the art will recognize that any number of user, mobile device, processor, repository, user account, reward point register, task list, reward list, and/or any other component shown in FIG. 1 may be included in the system (100) without departing from the spirit of the invention.

As shown in FIG. 1, the user (101) may be an individual interacting with the processor (110) to access the personalized reward system for himself/herself or on behalf of another person or an entity, to manage the task schedule (133) and/or to browse the reward point register (130). In one or more embodiments, the processor (110) and the repository (120) may be included in a self-contained system (e.g., a mobile device, a desktop computer, etc.) that are directly accessed by the user (101). In one or more embodiments, the user (101) may access the processor (110) (e.g., an Internet based web server) using a mobile device (102), (e.g., mobile phone, PDA, etc.) via a network (103) (e.g., Internet). In one or more embodiments, the access to the personalized reward system (100) may be controlled via the user account (132), which includes various administration and authentication information known to those skilled in the art. In one or more embodiments, the user account (132) may be configured to allow someone or some entity other than the user (101) to access portions of the personalized reward system information belonging to the user (101). The designation of sharable information and administration of the share access may be implemented using techniques known to those skilled in the art.

In one or more embodiments, the task schedule (133) includes various task entries similar to a to-do list known to those skilled in the art and may be accessed, updated, or otherwise managed in a similar manner. The various task entries are instantiated from a task list (140) described below. For example, a task entry may be checked off by the user (i.e., based on a user input) when it is accomplished/completed. In one embodiment, the task schedule (133) may be additionally annotated with reward point information. In other embodiments, the task schedule (133) may be linked to the task list (140) where reward information resides.

In one or more embodiments, the task list (140) includes one or more tasks (141, 144, etc.) each having a task name (142, 145, etc.) (e.g., taking out garbage, getting milk, walking dog, exercising, etc.), an associated reward points (143, 146, etc.) that can be earned when a task if completed (e.g., one point may be earned when taking out garbage is completed, etc.). In one or more embodiments, one or more task may be further associated with other attribute information, such as frequency, duration, priority, etc. such that the task schedule (133) may be populated automatically. In one or more embodiments, bonus point may be added to regular reward points if a particular task entry has raised priority, completion of the task is in a prompt manner, or certain special condition is met. For example, the raised priority, the prompt completion, and/or the special condition may be specified by the user. In one or more embodiments, one or more task may be further associated with a goal (147) that includes a threshold and a due date (not shown). For example, the goal (147) associated with the exercising task (145) may include reaching a particular body weight within a due date.

In one or more embodiments, the reward point register (130) may store a tally of all earned reward points (135) (i.e., accumulated reward points). In one or more embodiments, the reward point register (130) may optionally include one or more reward point allocation (131) where a portion of the accumulated reward point may be allocated to certain target reward. In one embodiment, the allocation may be based on a pre-determined (e.g., user defined) allocation schedule. In other embodiments, the allocation may be entered manually by the user (101).

In one or more embodiments, the reward list (150) includes one or more rewards (151, 154, etc.) each having a reward name (152, 155, etc.) (e.g., digital camera, motor cycle, Hawaii trip, etc.), an associated redemption reward points (153, 156, etc.) that are required for redemption of the reward (e.g., 1000 points may be required for redemption of the digital camera). In one or more embodiments, one or more reward may be associated with other attribute information, such as desirability, earned point allocation priority, visibility, etc. For example, accumulated reward points (135) in the reward point register (130) may be optionally allocated to one or more reward according to the associated earned point allocation priorities. In another example, certain reward may be a secret reward (e.g., specified by someone other than the user (101)) of which the name and/or the associated required redemption points are made invisible to the user (101).

In one or more embodiments, the task schedule (133), the task list (140), the reward list (150), and/or the reward point register (130) may be associated with a project (not shown). In one or more embodiments, multiple projects may be set up in the personalized reward system where each project may be associated with individual corresponding task schedule, task list, reward list, and reward point register. In one or more embodiments, task schedule, task list, reward list, and/or reward point register may be shared among more than one projects.

In one or more embodiments, the input/output module (111) may be configured to obtain the task list (140), obtain the reward list (150), and/or receive user inputs to browse, set up, update, adjust, or otherwise access the task list (140), reward list (150), user account (132), task schedule (133), and/or reward point register (130). For example, the task list (140), reward list (150), user account (132), task schedule (133), and/or reward point register (130) may be initially set up using pre-determined templates and subsequently populated or configured based in user inputs via the input/output module (111). Particularly, a task entry in the task schedule (133) may be checked off based on a user input via the input/output module (111). In one or more embodiments, the input/output module (111) may be accessed by the user (101) using the mobile device (102) via the network (103). In one or more embodiments, the input/output module (111) may be accessed by the user (101) directly.

In one or more embodiments, the reward point accumulator (112) may be configured to tally the earned reward points each time when the user (101) checks off a completed task entry in the task schedule (133). For example, the earned reward points correspond to the completed task may be looked up from the task list (140) and added to the accumulated reward point (135).

In one or more embodiments, the reward redemption analyzer (113) may be configured to compare the accumulated reward points (135) and/or the reward point allocation (131) to each of the redemption points (153, 156, etc.) for generating an analysis result indicating whether one or more reward is ready for redemption.

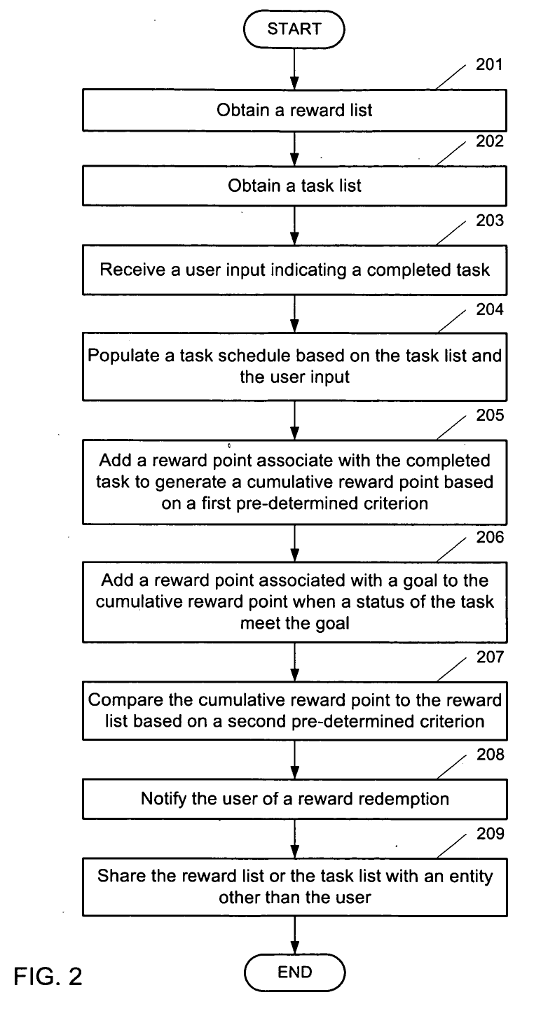

FIG. 2 depicts a flowchart of a method in accordance with one or more embodiments of the invention. In one or more embodiments of the invention, one or more of the steps shown in FIG. 2 may be omitted, repeated, and/or performed in a different order. Accordingly, embodiments of the invention should not be considered limited to the specific arrangements of steps shown in FIG. 2.

In one or more embodiments of the invention, the method depicted in FIG. 2 may be practiced using personalized reward system (100) described with respect to FIG. 1. Initially, a reward list may be obtained that includes one or more reward each associated with a corresponding reward point required for a corresponding reward redemption (Step 201).

In Step 202, a task list may be obtained that includes one or more tasks each associated with a corresponding reward point that can be earned upon a corresponding task completion.

In Step 203, an input from a user may be received indicating a task of the one or more tasks is completed. For example, a completed task may be checked off by the user using a mobile device.

In Step 204, a task schedule may be populated based on the task list and the input from the user. For example, one or more tasks in the task list may be instantiated according to associated frequency, duration, priority, etc. into a task schedule. In one or more embodiments, the order or sequence of the tasks in the task schedule may be randomized to avoid being overly repetitive.

In Step 205, a corresponding reward point associate with the task completed in Step 203 may be added to generate a cumulative reward point based on a first pre-determined criterion. For example, the reward points may be tallied by a reward point counter. In one or more embodiments, the first pre-determined criterion may adjust the added reward points, for example based on a weighed scheme, to encourage completion of prioritized tasks or completing tasks on an accelerated schedule.

In one or more embodiments, the task list may also include a goal associated with a reward point that can be earned upon achieving the goal. For example, the goal may be based on a task and includes a threshold and a due date. In Step 206, the reward point associated with the goal may be added to the cumulative reward point when the threshold and the due date of the goal are met by a status of the task. For example, a monitored item (e.g., body weight) may be defined by the user that is related to a task (e.g., exercising) while the goal may be defined as reaching a certain target body weight (i.e., the threshold) within a target time frame (i.e., the due date). In this example, the reward point associated with the goal may be added into the accumulated reward point when the target body weight is met within the target time frame.

In Step 207, the cumulative reward point, for example tallied by a reward point counter, may be compared to the reward list based on a second pre-determined criterion to generate a result. For example, one or more reward in the reward list whose associated redemption reward points exceeded by the cumulative reward point may be identified as redeemable reward. In one or more embodiments, the second pre-determined criterion may consider desirability, priority, allocation, etc. of each reward specified by the user.

In Step 208, the user may be notified of a reward redemption based on the comparison result of Step 207. For example, the user may receive a message or an email from the mobile device.

In Step 209, the reward list and/or the task list may be shared with an entity other than the user, for example an entity authorized by the user (e.g., a friend or family member) or an entity having supervisory authority over the user (e.g., a parent). For example, the entity other than the user may be allowed to access (e.g., retrieve or modify) the reward list and/or the task list of the user. For example, a friend may access the reward list to add a secret reward hidden from the user such that the user may receive a surprise reward when the redemption criterion (e.g., meeting a goal or reaching a required redemption point) is satisfied.

In one or more embodiments, the reward list, the task list, and/or the task schedule may be presented to the user for viewing or modification.

In one or more embodiments, Steps 201, 202, 204, 205, 206, 207, and/or 209 may be performed using a server while Steps 203 and/or 208 may be performed via a mobile device operatively coupled to the server. For example, the server may be an Internet web server while the mobile device may be a PDA with wireless Internet access.

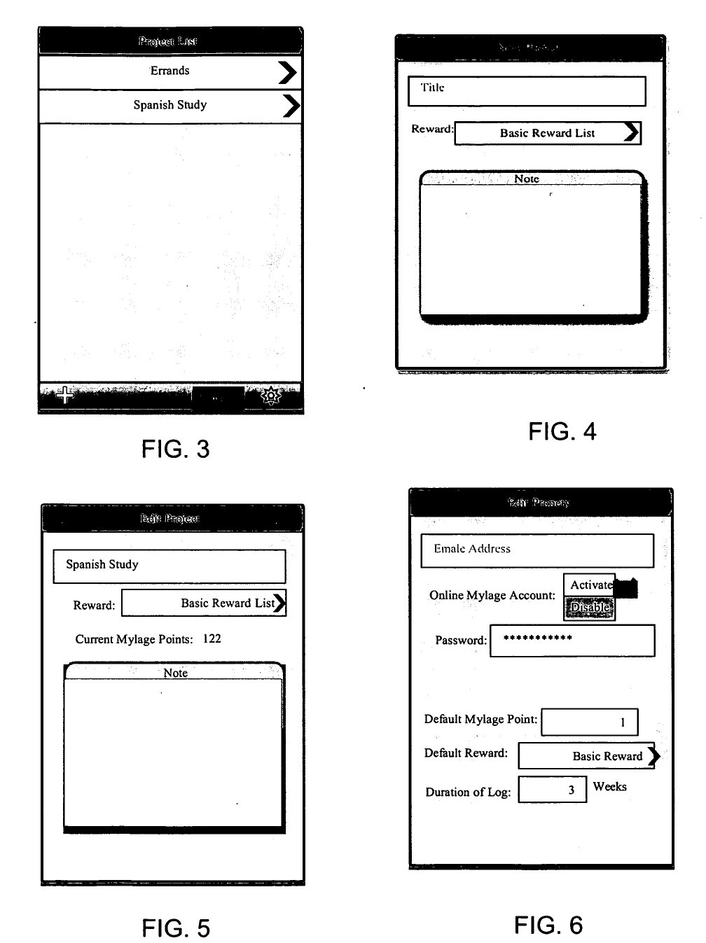

FIGS. 3-34 depict screen shots of an example personalized reward system according to aspects of the invention. The personalized reward system is named “Mylage” and is build with iPhone in its core. The iPhone is connected to the Internet via wireless connection, so that the application can talk to the main server. The server on the Internet provides the user account mechanism such that the user can backup the information on the iPhone, and exchange information (e.g., reward list) with other users. In addition to iPhone, web page can be viewed and manipulated via ordinary personal computers.

The Mylage tasks are usually provided as task list with various to-do items. The user can earn the Mylage points for daily trivial tasks such as “Put garbage on every Monday”. By earning the points, the user will feel encouraged and be motivated.

The user also can setup its own rewards so that he/she can redeem the rewards according to the earned Mylage points. The rewards are defined by users to treat themselves (or by family, company, etc.), and could be anything such as “Go to Hot Spring Trip”. The reward can have URL entry to link it to a specific web page, so that the user can jump to view descriptions relating to the reward.

Addition to the to-do items, Mylage system can put a monitored item into the list to trace a value. The value could be body weight, jogging distance, study hours, expenses, sales, etc. The monitored item will show up on the project view where the user can enter the daily changes of the value. The goal points (i.e., the earned Mylage point for reaching the goal) can be set for rewarding based on the monitored value.

### Project List and Task List

The software on iPhone has various views for the user to enter and browse various items. For example, Mylage software may start from a Project-List view having project “Errands” and “Spanish Study.” Each project contains a project view with a task list. By touching ‘>’ button on the list moves the screen to the project view as shown in FIG. 9. The terms “screen”, “window”, and “display” are used interchangeably based on the context throughout the description of these example screen shots. The project view shows a task list to be done. This example list includes task entries such as “Monday Garbage”, “Got Milk”, “Dog Walk”, and “Body Weight Monitor” and is similar to the to-do list in ordinary to-do list software with the exception that each task is assigned with Mylage point (i.e., reward point). It also has smarter mechanisms for ease of use. It has an automated task creation mechanism so that the user can set up the same task in a repeated fashion (e.g., daily, weekly, etc.). It also provides some randomness to spread various tasks in a schedule (i.e., task schedule) without being overly repetitive.

In addition, each task can be set up so that it is automatically assumed to be done at the end of the day. Thus the user does not have to manually check it as “done” to earn the Mylage point. The user can remove it from the history record if the task is not completed.

### 2.1 Project List View (FIG. 3)

As discussed above, the project List View shows the list of projects, for example “Errands” and “Spanish Study.” Each of these projects may have a corresponding to-do list, a corresponding Mylage point counter, and a corresponding reward list, which are individually set up per project. In some example, a reward list can be shared among multiple projects.

Touching each of the projects in the project list screen will move the window to the project view. Touching ‘Edit’ button will show editing function, for example the delete action for the project. Touching ‘>’ button will move the window to Edit-Project view. Touching ‘+’ button will move the window to Add-Project view. Touching ‘Reward’ button will move the window to Reward-Set-List View. Touching ‘*’ button will move the window to edit-property view.

### 2.2 Add-Project View (FIG. 4)

When Mylage software is started at the very first time, it has a single project “Errands” in the project list view. By touching ‘+’ bottom, the window moves to Add-Project View. In the Add-Project View, the user can set the project name, choose a reward list, and set up various attributes of the project. The first box in this view is the title of the project. By touching the inside of the title box, a cursor is caused to be displayed in the box and the virtual keyboard (not shown) will show up on the bottom of the Add-Project view for typing in the project name. The second box shows the reward set for this project. Touching ‘>’ button on the box will move the window to Reward-Set-List view. The third box is a note for the project. Any text can be typed in here for a memo purpose. ‘Save’ button will save the new project and return the screen to the project list view. ‘Cancel’ button will discard the entry and return the screen to the project list view.

### 2.3 Edit-Project View (FIG. 5)

This view is similar to Add-Project View, with the top title shows ‘Edit Project’ and the Project Title box is filled with the selected project name (e.g., Spanish study). It also shows the current Mylage points 122 for the project.

### 2.4 Edit-Property View (FIG. 6)

This view is used to setup various preferences for Mylage software.

The preferences includes:
E-mail address for the user. This is also used for account ID on the server.
Switch to enable/disable the online connection to the server.
Default Mylage point for a new task
Default reward list for a new project
Duration that the completed tasks are kept in the log.

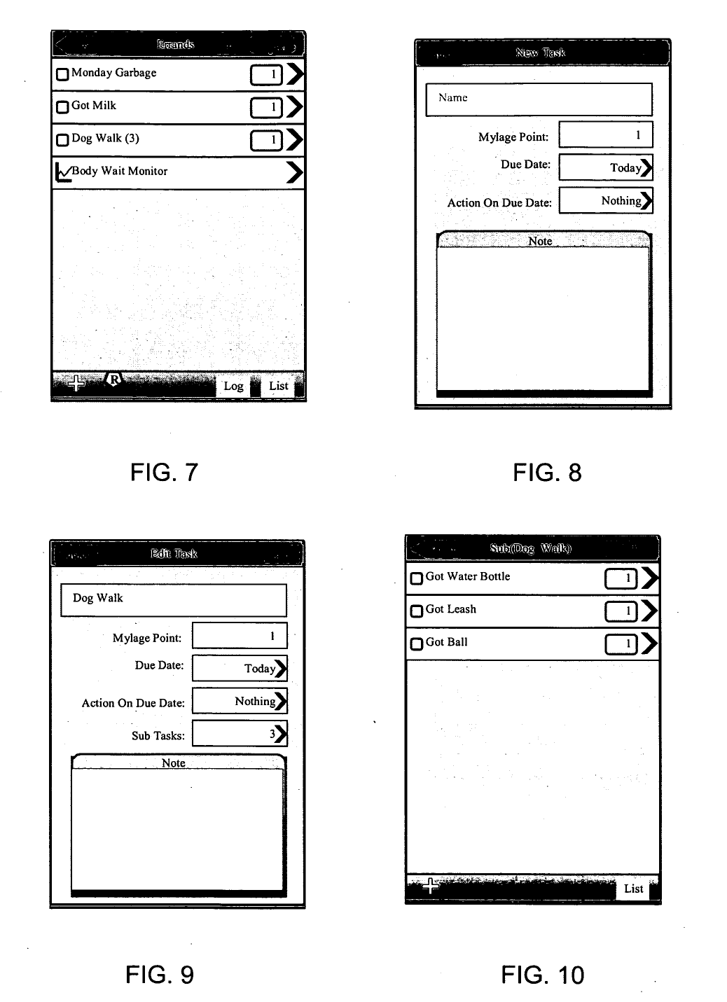

### 2.5 Project View (FIG. 7)

Project View shows the list of tasks to be done in the selected project. Each Task has check box on the left, the task name, Mylage point, and ‘>’ button. The monitor task has the monitor icon on the left (e.g., body weight monitor).

Touching the check box on the will show the box checked. Touching the ‘Update’ button on the top will remove the checked task(s) and add Mylage points to the Mylage point counter.

Touching the ‘List’ button on the top will return the window back to the Project List View. When any check box is modified (and not saved), a pop-up window will show up asking the user whether to save it or not.

Touching ‘>’ button on the task will move the window to Edit-Task View. For monitor task, it will move the window to Update-Monitor View.

Touching ‘+’ button will move the window to New-Task View.

Touching ‘R’ button will move the window to Get-Reward View.

Indication will be shown on this ‘R’ button when reward is available for the current accumulated Mylage point.

Touching ‘Log’ button on the bottom will move the window to Log View.

Touching ‘List’ button on the bottom will move the window to Task-List View. Task list view shows the previous task that the user saved, so it can be used repeatedly.

### 2.6 New-Task View (FIG. 8)

This view is used to add a new task to a project. The first box is for the task name. The second box is Mylage point for the task. The third box shows the due date. Touching ‘>’ button will move the window to Set-Due-Date View. The forth box shows the automatic action at the end of the Due Date. Touching ‘>’ button will move the window to Set-Action View.

For the action:
‘Nothing’ will do nothing and task remains on the list after due date.
‘Complete’ will move the task to be completed on the end of the due date.
‘Remove’ will take out the task from the list on the end of due date.

The fifth box is the note for the task.

‘Save’ button will save the new task and back to the project view. The pop-up window will show up to ask if the user wants to save the new task to the task list.

‘Cancel’ button will discard the entry and back to the project view.

### 2.7 Edit-Task View (FIG. 9)

This view is similar to New-Task View, with an additional box that shows the number of sub-tasks. In general, any task on the task list (including sub-task list under a task) can add sub-task at any level. Thus, a complicated task can be sub-divided onto smaller tasks for multiple levels. Touching ‘>’ button on the sub-task box will move the window to the Sub-Tasks view.

### 2.8 Sub-Tasks View (FIG. 10)

This view shows all the sub-tasks on given parent task and is similar to the Project View.

Touching ‘+’ button will move the window to New-Task View for adding sub-task.

Touching ‘List’ button will move the window to Task-List View, for selecting tasks previously stored under the parent task.

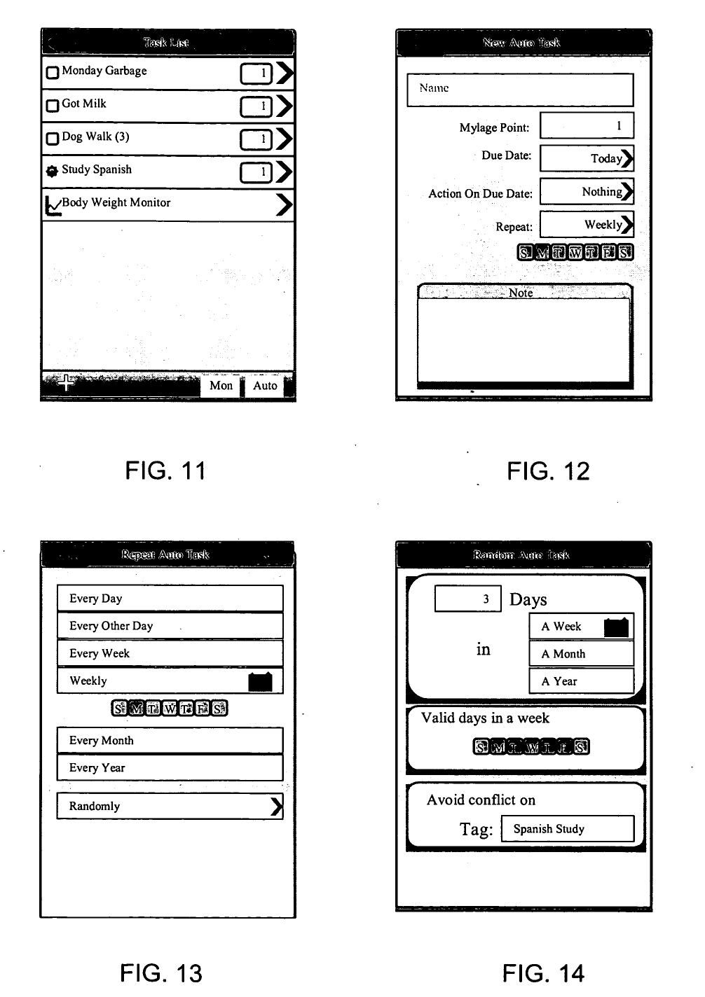

### 2.9 Task-List View (FIG. 11)

This view shows the saved previous tasks for reuse.

Touching check box will show the check mark.

Touching ‘Add’ button will add the selected task(s) and move the window to the Project View.

Auto tasks are shown with ‘*’ mark instead of check box.

Monitor tasks are shown with a graph mark.

Touching ‘Auto’ button on the bottom will move to Add-Auto-Task View.

Touching ‘Mon’ button on the bottom will move to Add-Monitor View.

### 2.10 New-Auto-Task View (FIG. 12)

This view is used for creating an auto task. Auto task is automatically created in repeated manner. An active auto-task is kept in the task list. This view is similar to New-Task View, with additional box to setup the repetition, and the box to show day selection on a week (only valid on ‘Weekly’ choice).

Touching ‘>’ button on the repeat box will move the window to Set-Repeat view.

### 2.11 Set-Repeat View (FIG. 13)

This view is used to set repetition for an auto task.

By touching a box, the check mark will show up on the box.

For ‘Weekly’ box, the days on a week selection can be made. Multiple days can be selected.

Touching ‘>’ button on ‘Randomly’ box will move the window to Set-Random view.

### 2.12 Set-Random View (FIG. 14)

This view is used to set random repetition for an auto task.

First section selects how many days in a week, a month, or a year.

Second section selects valid days in a week. The system only picks valid days selected here.

Third section specifies a tag name. The system tries to avoid a conflict on the same day with the same tag name in a project.

Random day selection will be done in the best effort. If system can not find a possible day under given condition, various mismatches (less than specified days, conflict on the same tag, etc.) may happen.

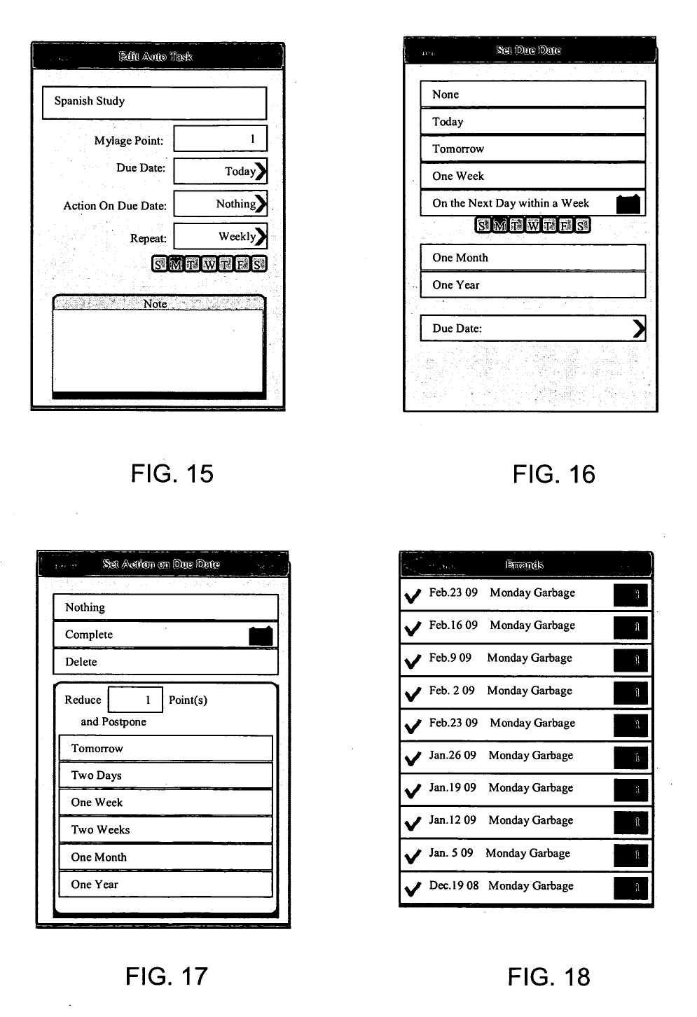

### 2.13 Edit Auto Task View (FIG. 15)

This view is used to edit auto task in the task list.

This view is the same as New-Auto-Task View, except that the title on the top.

### 2.14 Set-Due-Date View (FIG. 16)

This view is used to set the due date on a task.

By touching a preferred box, a check mark will show up.

For the “On the Next Day within a week” box, one day on one week boxes can be made.

Touching ‘>’ button on “Due Date:” box will show the Date Picker View. With this, a specific date can be selected.

### 2.15 Set-Action View (FIG. 17)

This view is used to set the action on the due date on a task.

By touching a preferred box, a check mark will show up.

### 2.16 Log View (FIG. 18)

This view shows the completed tasks for the project.

Touching ‘Edit’ button will show the delete action for each item. Deleting from the list will reduce the Mylage count accordingly.

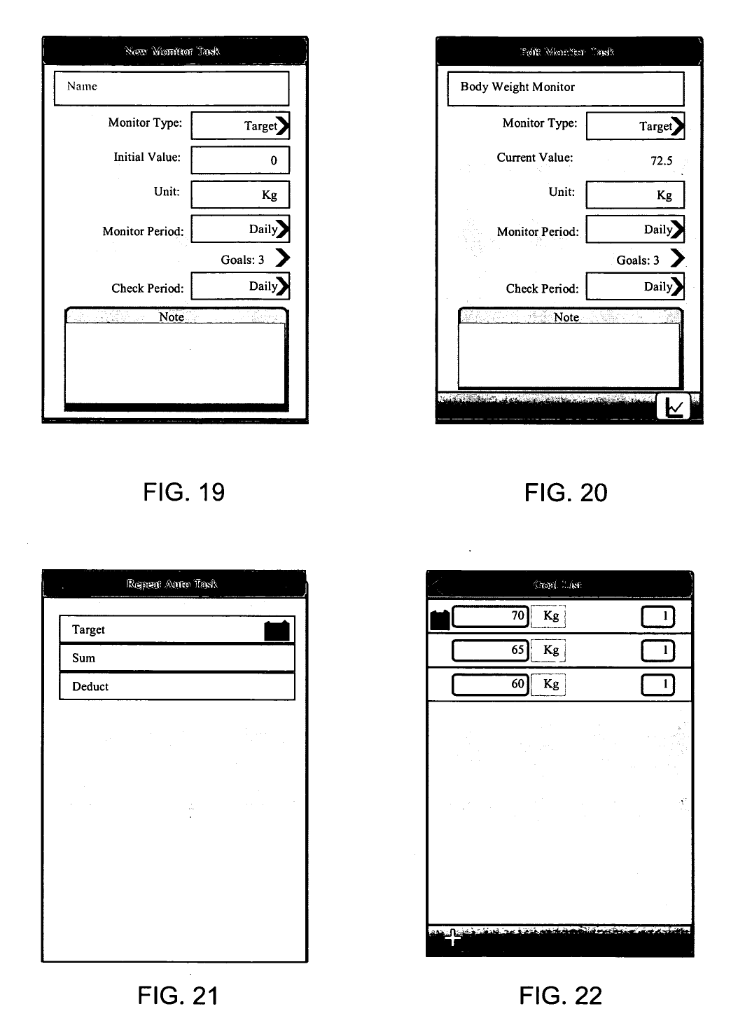

### 2.17 New Monitor View (FIG. 19)

This view is used to create a Monitor Task in Task-List.

The monitor task is a task to monitor a value (e.g. body weight). The goal(s) and corresponding Mylage point(s) are set, so that the user will earn the point when the goal is achieved.

There are three types of basic monitor task activities:

Target: This type of task monitors the current value and check if it satisfied the target value. This can be used to monitor body weight, height, etc.

Sum: This type of task monitors the sum of daily value, and check if the total satisfied the goal. This can be used to monitor daily study hours, sales, etc.

Deduct: This type of task monitors the deduction of daily value from the initial value. This can also be used for a kind of budget monitoring.

The view contains:
Name: enter the name of the monitor task
Type: select a type of monitor.
   Touching ‘>’ button moves to Select-Mon-Type View.
Unit: enter a unit of monitored value. This is for display purpose only.
Goals: this shows how many goals are set. Touching ‘>’ moves to Goal-List View
Monitor Period: This determines how frequent the value to be monitored.

According to this period, the monitor task generates a check task to the task list in Project View. Touching ‘>’ moves to Select-Period View.
Check Period: This determines when the goal value is evaluated.
   Defining this is useful for budged type goal.
   (e.g., How much left at the end of month.)
   Project View. Touching ‘>’ moves to Select-Period View.
Note: note for the task.

### 2.18 Edit Monitor View (FIG. 20)

This view is used to edit a Monitor Task in Task-List.

This is the same as New-Monitor View, except the top name.

Touching the monitor icon button on the bottom will show the graph of the monitored value.

### 2.19 Select Mon-Type View (FIG. 21)

This view is used to select the Monitor type.

Touching a box will show the check mark.

### 2.20 Goal List View (FIG. 22)

This view shows the goals for the monitor task.

The check mark will be shown to the achieved goal.

Touching ‘+’ button moves the window to New Goal View.

Touching a goal box moves the window to Edit Goal View.

Touching ‘Edit’ button to delete goals on this list.

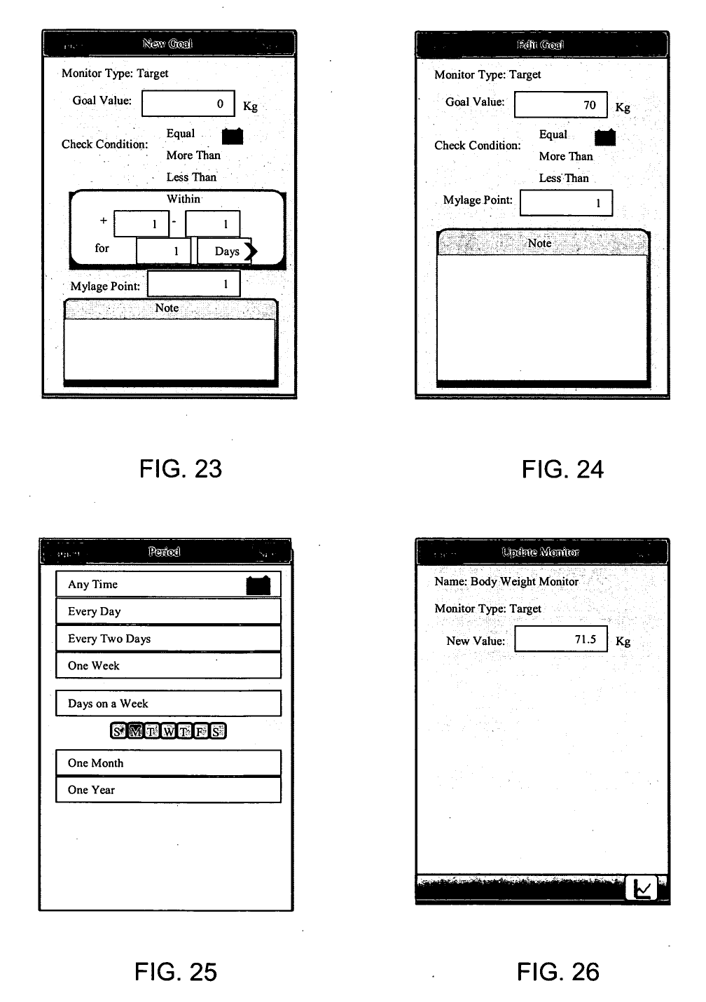

### 2.21 New Goal View (FIG. 23)

This view is used to add a new goal to the goal list.

Goal Value is the target value of this goal.

Check condition is how the current value is checked with the goal value.

‘Equal’ means the current value is crossed or on the goal value.

‘More Than’ means the current value is larger than the goal value.

‘Less Than’ means the current value is less than the goal value.

Last ‘Within’ box is to specify the stability of the value. The user gets the point when the value is stable within the given range (± values) for given period.

The check is done at the specified check period, and will only be detected once.

### 2.22 Edit Goal View (FIG. 24)

This view is used to edit a goal on the goal list.

Resaving the achieved goal (with check mark) will clear the check mark and reactivate the goal.

### 2.23 Select Period View (FIG. 25)

This view is used to select a period for the monitor task.

When ‘Any Time’ is selected for monitor period, a monitor task is always shown in the Project View, so that a new value can be entered any time.

### 2.23 Update Monitor View (FIG. 26)

This view is used to update the monitor value from Project View.

Touching the monitor icon button on the bottom will show the graph of the monitored value.

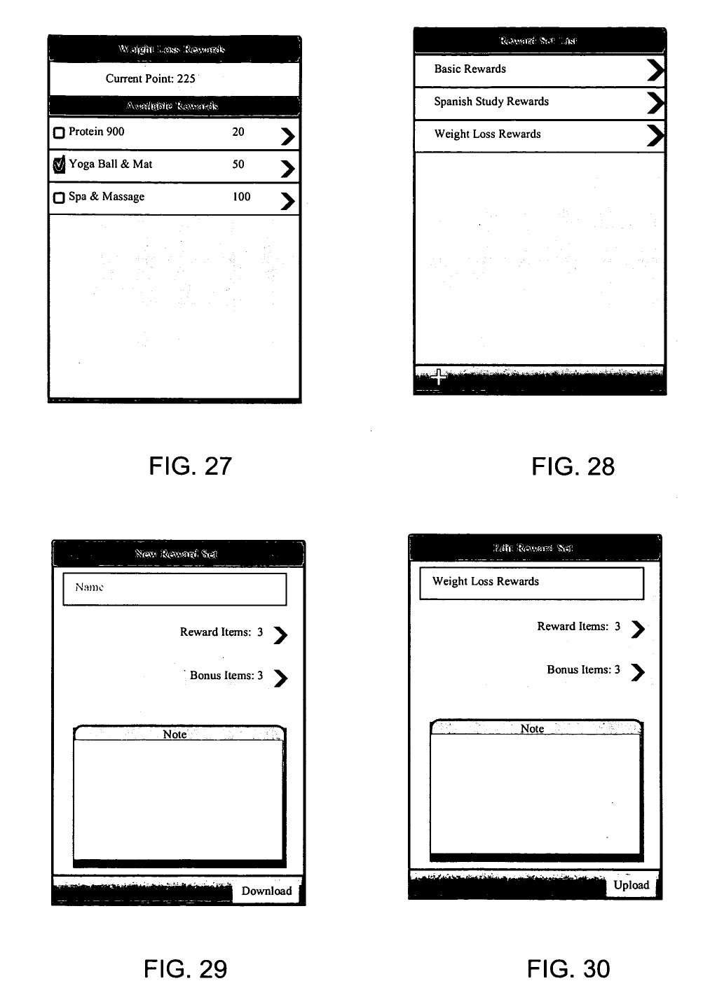

### 2.24 Get Reward View (FIG. 27)

This view is used to get available reward for current Mylage point.

Selecting a reward by touching the box on the left, then touch ‘Get’ button to get the reward.

The reward point will be subtracted from the current point.

Touching ‘>’ button will show the detail of the reward.

### Reward Set Creation

A reward set (i.e., reward list) contains Reward-Items with corresponding Mylage point. A reward set may be selected for a project to reward the accomplishment of tasks in the project. All the reward set is listed under Reward-Set List View. Reward List View is accessible from Project-List View (very top) or via Add-Project View or Edit-Project View.

### 3.1 Reward-Set List View (FIG. 28)

This view shows the Reward set for a user.

Touching a box will highlight it for selection in the case it is coming from Add-Project View of Edit-Project View.

Touching ‘Edit’ button to delete the item(s) on the list

Touching ‘>’ button will move to Edit-Reward-Set View

Touching ‘+’ button will move to New-Reward-Set View

### 3.2 New Reward-Set View (FIG. 29)

This view is used to edit a new reward set.

A reward set can have multiple reward items and bonus items.

A reward items are items that when the user takes the reward, the required point for the reward will be subtracted from the total Mylage point.

A bonus items are items that can be taken without subtraction, when the total point reaches to the required point. Bonus items can be hidden with password so that a surprise bonus can be made.

The first box is to enter the name of the reward set.

The second part shows the number of reward items in this set.

Touching ‘>’ moves to Reward-Item-List View.

The third part shows the number of bonus items in this set. Number for Bonus items with password will not be shown.

Touching ‘>’ moves to Bonus-Item-List View.

Touching ‘Download’ will show prompt to download Reward-set from Internet.

### 3.3 Edit-Reward-Set View (FIG. 30)

This view is used to create a new reward set.

This view is the similar to New-Reward-View.

Touching ‘Upload’ button will upload this reward set to the Internet. (detail TBD)

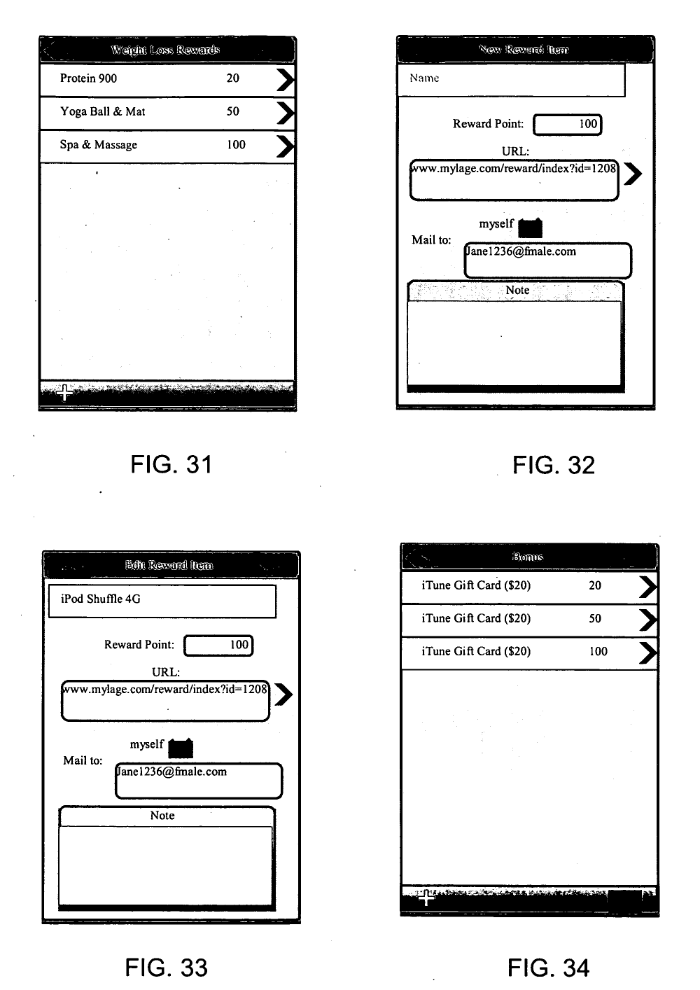

### 3.4 Reward-Item-List View (FIG. 31)

The list shows reward items in the list.

Touching ‘Edit’ button to delete the item(s) on the list

Touching ‘>’ button will move to Edit-Reward View

Touching ‘+’ button will move to New-Reward View

### 3.5 New Reward-Item View (FIG. 32)

This view is used to enter a new reward item.

Each reward item has the following information
1) Name: to be the name of this reward
2) Point: required point to get this reward
3) URL: related URL (e.g. the product page on Amazon)
4) Mail to: selecting ‘myself’ will mail to the user additional address(es) to inform when the reward is taken.
5) Note: Additional explanation

Touching ‘save’ button to save the item

Touching ‘cancel’ to abort the item entry

Touching ‘>’ button will jump to the given URL (by moving the screen to an Internet browser, e.g., Safari)

### 3.6 Edit Reward-Item View (FIG. 33)

This view is used to edit an existing reward item. This is basically the same as New-Reward-Item View.

### 3.7 Bonus-Item-List View (FIG. 34)

The list shows reward items in the list.

Touching ‘Edit’ button to delete the item(s) on the list

Touching ‘>’ button will move to Edit-Reward View

Touching ‘+’ button will move to New-Reward View

Touching ‘PW’ to setup the password. The password setup view will show up.

Once a password is set, it is required to enter the password to see the Bonus Item List View. The number of bonus is hidden with ‘*’ character.

### Workflow for Major Activities

### 4.1 Project View Flow

The Project view has the task list. The items to be done on the day are listed here. This is the main screen that the user checks daily. When user finds that a task is completed, touch the box on the left. Then the check mark is shown on the box. Then touching update button on the top right, the marked task will be removed from this view, and the point is accumulated. If the accumulated point exceeds the required reward point, it is informed to the user with a message.

### 4.2 Get-Reward View Flow

The Get-Reward-View will be used when the user is ready to take the reward. The check mark will be shown when the user touches the box on the left. Then touching ‘Get’ button on the top right on the view, the reward is taken and the point is subtracted.

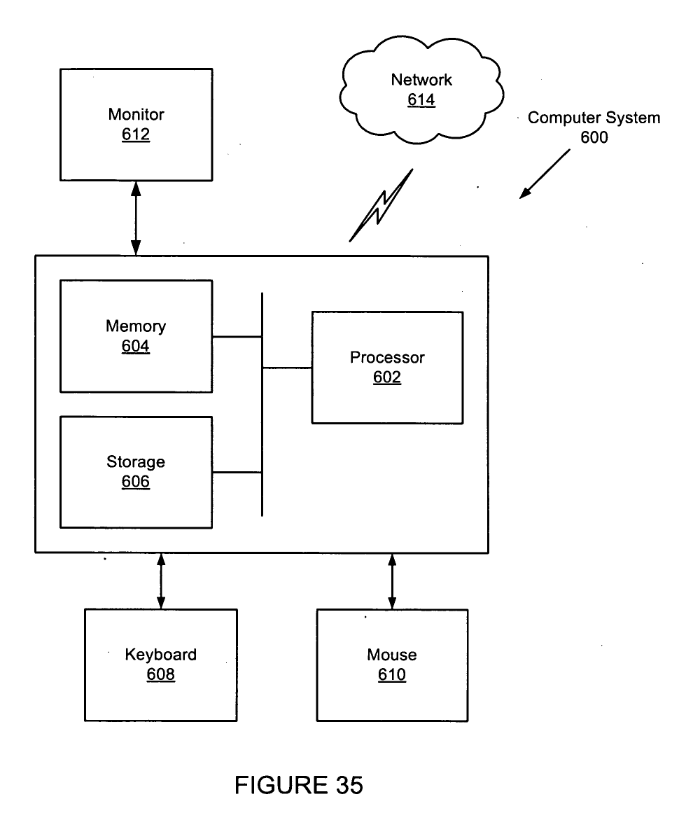

Embodiments of the invention may be implemented on virtually any type of computer regardless of the platform being used. For example, as shown in FIG. 35, a computer system (600) includes one or more processor(s) (602), associated memory (604) (e.g., random access memory (RAM), cache memory, flash memory, etc.), a storage device (606) (e.g., a hard disk, an optical drive such as a compact disk drive or digital video disk (DVD) drive, a flash memory stick, etc.), and numerous other elements and functionalities typical of today's computers (not shown). The computer (600) may also include input means, such as a keyboard (608), a mouse (610), or a microphone (not shown). Further, the computer (600) may include output means, such as a monitor (612) (e.g., a liquid crystal display (LCD), a plasma display, or cathode ray tube (CRT) monitor). The computer system (600) may be connected to a network (614) (e.g., a local area network (LAN), a wide area network (WAN) such as the Internet, or any other similar type of network) with wired and/or wireless segments via a network interface connection (not shown). Those skilled in the art will appreciate that many different types of computer systems exist, and the aforementioned input and output means may take other forms. Generally speaking, the computer system (600) includes at least the minimal processing, input, and/or output means necessary to practice embodiments of the invention.

Further, those skilled in the art will appreciate that one or more elements of the aforementioned computer system (600) may be located at a remote location and connected to the other elements over a network. Further, embodiments of the invention may be implemented on a distributed system having a plurality of nodes, where each portion of the invention (e.g., various components of FIG. 1) may be located on a different node within the distributed system. In one embodiments of the invention, the node corresponds to a computer system. Alternatively, the node may correspond to a processor with associated physical memory. The node may alternatively correspond to a processor with shared memory and/or resources. Further, software instructions for performing embodiments of the invention may be stored on a computer readable medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of a personalized reward system, comprising:
obtaining a reward list comprising one or more reward each associated with a corresponding reward point required for a corresponding reward redemption;
obtaining a task list comprising one or more tasks each associated with a corresponding reward point that can be earned upon a corresponding task completion;
receiving an input from a user indicating a task of the one or more tasks is completed;
adding a corresponding reward point associate with the task to generate a cumulative reward point based on a first pre-determined criterion;
comparing the cumulative reward point to the reward list based on a second pre-determined criterion to generate a result; and
notifying the user of a reward redemption based on the result.

2. The method of claim 1,
wherein the task list further comprises a goal associated with a reward point that can be earned upon achieving the goal, and
wherein the goal is based on a task and comprises a threshold and a due date,
the method further comprising adding the reward point associated with the goal to the cumulative reward point when a status of the task meets the threshold and the due date.

3. The method of claim 2, further comprising:
receiving a value of a monitored item from the user, wherein the monitored item is related to the task on which the goal is based,
wherein the status of the task is defined based on comparing the value of the monitored item to the threshold and the due date of the goal.

4. The method of claim 1, further comprising:
populating a task schedule based on the task list and the input from the user; and
presenting at least one selected from the reward list, the task list, and the task schedule to the user for viewing.

5. The method of claim 4, further comprising adjusting at least one selected from the reward list, the task list, and the task schedule based on an input of the user.

6. The method of claim 1, further comprising adjusting at least one selected from the reward list and the task list based on an input of a pre-determined entity other than the user.

7. The method of claim 6, wherein adjusting the reward list based on the input of the pre-determined entity other than the user comprises:
adding, to the reward list, a secret reward associated with a secret reward point, wherein at least one selected from the group consisting of the secret reward and the secret reward point is not viewable by the user prior to redemption of the secret reward.

8. The method of claim 6, wherein the pre-determined entity other than the user comprises at least one selected from a group consisting of an entity authorized by the user and an entity having supervisory authority over the user.

9. The method of claim 1, wherein the reward comprises a name of the reward and a web link for accessing description of the reward.

10. The method of claim 1, wherein the input is received from the user using a mobile device of the user.

11. The method of claim 10,
wherein the reward list, the task list, and the cumulative reward points are stored on a server operatively coupled to the mobile device of the user, and
wherein adding the corresponding reward point associate with the task to generate a cumulative reward point and comparing the cumulative reward point to the reward list are performed using the server.

12. The method of claim 10, wherein the user is notified of the reward redemption via an email sent to the mobile device of the user.

13. The method of claim 10, further comprising sharing at least one selected from a group consisting of the reward list and the task list with an entity other than the user.

14. The method of claim 13,
wherein sharing comprises allowing the entity other than the user to access at least one selected from a group consisting of the reward list and the task list,
wherein the entity other than the user comprises at least one selected from a group consisting of an entity authorized by the user and an entity having supervisory authority over the user, and
wherein to access comprises at least one selected from a group consisting of to retrieve and to modify.

15. A personalized reward system comprising:
a repository for storing a reward list and a task list,
wherein the reward list comprises one or more reward each associated with a corresponding reward point required for a corresponding reward redemption, and
wherein the task list comprises one or more tasks each associated with a corresponding reward point that can be earned upon a corresponding task completion; and
memory storing instructions when executed by a processor comprising functionality for:
receiving an input from a user indicating a task of the one or more tasks is completed;
adding a corresponding reward point associate with the task to generate a cumulative reward point based on a first pre-determined criterion;
comparing the cumulative reward point to the reward list based on a second pre-determined criterion to generate a result; and
notifying the user of a reward redemption based on the result.

16. The personalized reward system of claim 15,
wherein the task list further comprises a goal associated with a reward point that can be earned upon achieving the goal, and
wherein the goal is based on a task and comprises a threshold and a due date,
the instructions when executed by the processor further comprising functionality for:
receiving a value of a monitored item from the user, wherein the monitored item is related to the task on which the goal is based, wherein a status of the task is defined based on comparing the value of the monitored item to the threshold and the due date of the goal; and
adding the reward point associated with the goal to the cumulative reward point when the status of the task meets the threshold and the due date.

17. The personalized reward system of claim 15, wherein the instructions when executed by the processor further comprising functionality for:
sharing at least one selected from a group consisting of the reward list and the task list with an entity other than the user,
wherein sharing comprises allowing the entity other than the user to access at least one selected from a group consisting of the reward list and the task list,
wherein the entity other than the user comprises at least one selected from a group consisting of an entity authorized by the user and an entity having supervisory authority over the user, and
wherein to access comprises at least one selected from a group consisting of to retrieve and to modify.

18. A computer readable medium storing instructions for a personalized reward system, the instructions when executed by a processor comprising functionality for:
obtaining a reward list comprising one or more reward each associated with a corresponding reward point required for a corresponding reward redemption;
obtaining a task list comprising one or more tasks each associated with a corresponding reward point that can be earned upon a corresponding task completion;
receiving an input from a user indicating a task of the one or more tasks is completed;
adding a corresponding reward point associate with the task to generate a cumulative reward point based on a first pre-determined criterion;
comparing the cumulative reward point to the reward list based on a second pre-determined criterion to generate a result; and
notifying the user of a reward redemption based on the result.

19. The computer readable medium of claim 18, the instructions when executed by the processor further comprising functionality for:
sharing at least one selected from a group consisting of the reward list and the task list with an entity other than the user,
wherein sharing comprises allowing the entity other than the user to access at least one selected from a group consisting of the reward list and the task list,
wherein the entity other than the user comprises at least one selected from a group consisting of an entity authorized by the user and an entity having supervisory authority over the user, and
wherein to access comprises at least one selected from a group consisting of to retrieve and to modify.

20. The computer readable medium of claim 19, the instructions when executed by the processor further comprising functionality for:
sharing at least one selected from a group consisting of the reward list and the task list with an entity other than the user,
wherein sharing comprises allowing the entity other than the user to access at least one selected from a group consisting of the reward list and the task list,
wherein the entity other than the user comprises at least one selected from a group consisting of an entity authorized by the user and an entity having supervisory authority over the user, and
wherein to access comprises at least one selected from a group consisting of to retrieve and to modify.
